(19) United States
(12) Patent Application Publication
(10) Pub. No.: US 2018/0254832 A1
(43) Pub. Date: Sep. 6, 2018

(54) OPTICAL RECEPTION DEVICE, OPTICAL MODULATOR AND OPTICAL MODULATION METHOD

(71) Applicant: FUJITSU LIMITED, Kawasaki-shi (JP)

(72) Inventor: Miki ONAKA, Kawasaki (JP)

(73) Assignee: FUJITSU LIMITED, Kawasaki-shi (JP)

(21) Appl. No.: 15/898,122

(22) Filed: Feb. 15, 2018

(30) Foreign Application Priority Data
Mar. 1, 2017 (JP) 2017-038205
Mar. 1, 2017 (JP) 2017-038220

(51) Int. Cl. H04B 10/532; H01S 3/067; G02B 6/293; H04B 10/66

(52) U.S. Cl. CPC H04B 10/532; H01S 3/06716; H04J 14/06; G02B 6/2938; H04B 10/66; G02B 6/29346

(57) ABSTRACT

An optical reception device includes an optical waveguide substrate that includes a polarization beam splitter that divides reception light into an X polarization component and a Y polarization component orthogonal to the X polarization component, a beam splitter that divides local light, a pair of optical hybrid circuits that causes each of the X polarization component and the Y polarization component to interfere with the divided local light, a first optical waveguide through which the reception light passes, a second optical waveguide through which the X polarization component passes, a third optical waveguide through which the Y polarization component passes, and a fourth optical waveguide through which the local light passes, wherein at least one of the first to fourth optical waveguides is doped with rare earth ions for amplifying light having a predetermined frequency when excitation light is introduced.

### CROSS-REFERENCE TO RELATED APPLICATION

This application is based upon and claims the benefit of priority of the prior Japanese Patent Application No. 2017-38220, filed on Mar. 1, 2017, and the prior Japanese Patent Application No. 2017-38205, filed on Mar. 1, 2017, the entire contents of which are incorporated herein by reference.

### FIELD

The embodiments discussed herein are related to an optical reception device, an optical modulator and an optical modulation method.

### BACKGROUND

In an optical transmission system with a high speed up to 100 Gbps, a digital coherent optical transceiver having an optical waveguide substrate in which various optical elements are formed on a semiconductor substrate is used. The optical waveguide substrate having various optical elements formed on a semiconductor substrate is also called a planar waveguide. The planar waveguide is a substrate on which optical elements such as an optical directional coupler (optical directional coupler), a polarization beam splitter (PBS), and an optical 90-degree hybrid circuit are formed. By adopting a planar waveguide capable of forming a plurality of elements on a single substrate, a digital coherent optical transceiver including an optical reception device is downsized. Japanese Laid-open Patent Publication No. 2014-157181, Japanese Laid-open Patent Publication No. 2010-54925, and Japanese Laid-open Patent Publication No. 8-242030 are disclosed as the related art, for example.

The digital coherent optical transceiver may be further downsized and low power consumption may be achieved by using light output from a light source as the transmission light, and dividing part of the light output from the light source by a beam splitter or the like and using the divided light as local light. By using part of the transmission light as local light, the reduction of the optical output power of the transmission light is suppressed. For this reason, the transmission light is modulated by an optical modulator and then amplified by an amplifier such as an erbium-doped fiber amplifier (EDFA). The EDFA includes an erbium-doped optical fiber with a length of several meters in which erbium ions (Er⁺³) are doped in the core. The EDFA is an amplifier that amplifies light in a 1.55 μm band by exciting erbium ions (Er⁺³) with excitation light. The transmission light output from the light source is modulated by the optical modulator and then multiplexed with the excitation light and amplified by the EDFA, whereby desired optical amplification characteristics are realized.

However, since the erbium-doped optical fiber included in the EDFA generally has a length of several meters, it is not easy to downsize the digital coherent optical transceiver that amplifies the transmission light by the EDFA.

An object of one embodiment is to provide an optical reception device, an optical modulator and an optical modulation method that are small and may obtain good optical amplification characteristics.

### SUMMARY

According to an aspect of the invention, an optical reception device includes an optical waveguide substrate that includes a polarization beam splitter that divides reception light into an X polarization component and a Y polarization component orthogonal to the X polarization component, a beam splitter that divides local light, a pair of optical hybrid circuits that causes each of the X polarization component and the Y polarization component to interfere with the divided local light, a first optical waveguide through which the reception light passes, a second optical waveguide through which the X polarization component passes, a third optical waveguide through which the Y polarization component passes, and a fourth optical waveguide through which the local light passes, wherein at least one of the first to fourth optical waveguides is doped with rare earth ions for amplifying light having a predetermined frequency when excitation light is introduced.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a block diagram of a digital coherent optical transceiver including a reception front end which is an example of an associated optical reception device;

FIG. 1B is an internal block diagram of an EDFA illustrated in FIG. 1A;

FIG. 2 is an internal block diagram of the reception front end illustrated in FIG. 1A;

FIG. 3 is a block diagram of a digital coherent optical transceiver including a reception front end which is an example of an optical reception device according to Embodiment 1-1;

FIG. 4 is an internal block diagram of the reception front end illustrated in FIG. 3;

FIG. 5A is a perspective view of an example of a first doped waveguide;

FIG. 5B is a front view of the first doped waveguide illustrated in FIG. 5A;

FIG. 5C is a perspective view of another example of the first doped waveguide;

FIG. 5D is a front view of the first doped waveguide illustrated in FIG. 5C;

FIG. 6 is an internal block diagram of a reception front end which is an example of an optical reception device according to Embodiment 1-2;

FIG. 7 is an internal block diagram of a reception front end which is an example of an optical reception device according to Embodiment 1-3;

FIG. 8A is a view for describing an operation of a beam splitter illustrated in FIG. 2;

FIG. 8B is a view for describing the operation of the beam splitter illustrated in FIG. 7;

FIG. 9 is an internal block diagram of a reception front end which is an example of an optical reception device according to Embodiment 1-4;

FIG. 10A is a block diagram of the digital coherent optical transceiver including a reception front end which is an example of an associated optical modulator;

FIG. 10B is an internal block diagram of the EDFA illustrated in FIG. 10A;

FIG. 11 is an internal block diagram of the optical modulator illustrated in FIG. 10A;

FIG. 12 is a block diagram of a digital coherent optical transceiver including an optical modulator according to Embodiment 2-1;

FIG. 13 is an internal block diagram of the optical modulator;

FIG. 14A is a perspective view of an example of the first doped waveguide;

FIG. 14B is a front view of the first doped waveguide illustrated in FIG. 5A;

FIG. 14C is a perspective view of another example of the first doped waveguide;

FIG. 14D is a front view of the first doped waveguide illustrated in FIG. 5C;

FIG. 15 is a diagram for describing an operation of the first doped waveguide, a second doped waveguide, and an optical directional coupler illustrated in FIG. 13;

FIG. 16 is an internal block diagram of an optical modulator according to Embodiment 2-2;

FIG. 17 is a diagram for describing an operation of the first doped waveguide, the second doped waveguide, and a PBC illustrated in FIG. 16;

FIG. 18 is an internal block diagram of an optical modulator according to Embodiment 2-3;

FIG. 19A is a diagram illustrating an arrangement relationship between the first doped waveguide, the second doped waveguide, and a radiation light detection sensor illustrated in FIG. 16;

FIG. 19B is a schematic perspective view of the first doped waveguide, the second doped waveguide, and the radiation light detection sensor illustrated in FIG. 19A;

FIG. 19C is a cross-sectional view including the first doped waveguide, the second doped waveguide, and the radiation light detection sensor illustrated in FIG. 19A; and

FIG. 20 is an internal block diagram of an optical modulator according to a modification example.

### DESCRIPTION OF EMBODIMENTS

An optical reception device according to an embodiment will be described below with reference to drawings. However, the technical scope of the present disclosure is not limited to these embodiments.

Before describing the optical reception device according to the embodiment, an optical reception device related to the optical reception device according to the embodiment will be described.

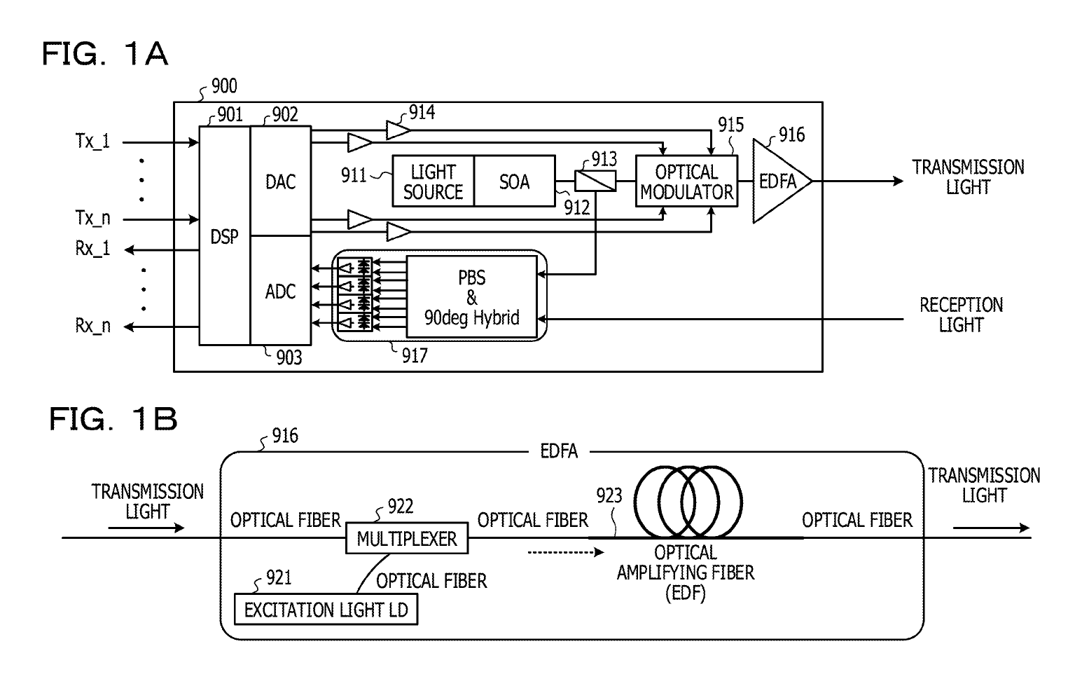

FIG. 1A is a block diagram of a digital coherent optical transceiver including a reception front end (FE) which is an example of an associated optical reception device. FIG. 1B is an internal block diagram of an EDFA illustrated in FIG. 1A.

A digital coherent optical transceiver 900 includes a digital signal processor (DSP) 901, a digital-to-analog converter 902, and an analog-to-digital converter 903. The digital coherent optical transceiver 900 further includes a light source 911, a semiconductor optical amplifier (SOA) 912, a beam splitter 913, a modulation driver 914, an optical modulator 915, and an EDFA 916. The digital coherent optical transceiver 900 further includes a reception front end 917.

The DSP 901 receives digital transmission signals Tx1 to Tx_n and executes a predetermined process on the data corresponding to the input digital transmission signals Tx1 to Tx_n to output a digital transmission signal indicating data that has undergone the predetermined process to the digital-to-analog converter 902. The DSP 901 receives a digital reception signal from the analog-to-digital converter 903 and executes a predetermined process on the data corresponding to the input digital reception signal to output digital reception signals Rx1 to Rx_n indicating data that has undergone a predetermined process. The digital-to-analog converter 902 performs digital-to-analog conversion on the digital transmission signal input from the DSP 901 to generate an analog transmission signal and outputs the generated analog transmission signal to the modulation driver 914. The analog-to-digital converter 903 performs analog-to-digital conversion on the analog reception signal input from the reception front end 917 to generate a digital transmission signal and outputs the generated digital reception signal to the DSP 901.

The light source 911 is, for example, a distributed feedback (DFB) laser, a sampled grating-distributed bragg reflector (SG-DBR) laser, a ring resonator laser, or the like. The light source 911 is a laser that outputs coherent light having desired optical characteristics. The coherent light output from the light source 911 is, for example, light in a 1.55 μm band.

The SOA 912 is formed of a semiconductor material such as GaAs and AIGaAs and is an amplifier that amplifies coherent light input from the light source 911. The beam splitter 913 is, for example, a pair of prisms having inclined surfaces joined to each other. The beam splitter 913 divides the coherent light amplified by the SOA 912 into two light beams at a predetermined ratio of a ratio of 1:1. The beam splitter 913 outputs one of the divided light beams to the optical modulator 915 and outputs the other divided light beam to the reception front end 917. The modulation driver 914 outputs the analog transmission signal input from the digital-to-analog converter 902 to the optical modulator 915. The optical modulator 915 outputs modulation light obtained by modulating the coherent light output from the light source 911 to the EDFA 916 based on the analog transmission signal input via the modulation driver 914. The optical modulator 915 generates modulation light by, for example, dual polarization quaternary phase-shift keying (DP-QPSK) of coherent light. Since the structures and functions of the SOA 912, the beam splitter 913, the modulation driver 914, and the optical modulator 915 are widely known, a detailed description thereof will be omitted here.

The EDFA 916 includes an excitation light laser 921, a multiplexer 922, and an optical amplifying fiber 923. The excitation light laser 921 is, for example, a distributed feedback laser, an SG-DBR laser, a ring resonator laser, or the like. The excitation light laser 921 generates excitation light for exciting the erbium ions (Er⁺³) in a 0.98 μm band or a 1.48 μm band and outputs the generated excitation light to the multiplexer 922. The multiplexer 922 is, for example, a WDM coupler. The multiplexer 922 multiplexes the modulation light input from the optical modulator 915 and the excitation light input from the excitation light laser 921 and outputs the multiplexed light to the optical amplifying fiber 923. The optical amplifying fiber 923 is, for example, an optical fiber having a length of several meters doped with erbium ions (Er⁺³) as a core. The optical amplifying fiber 923 is an amplifier that amplifies light in a 1.55 μm band when the excitation light is input from the excitation light laser 921.

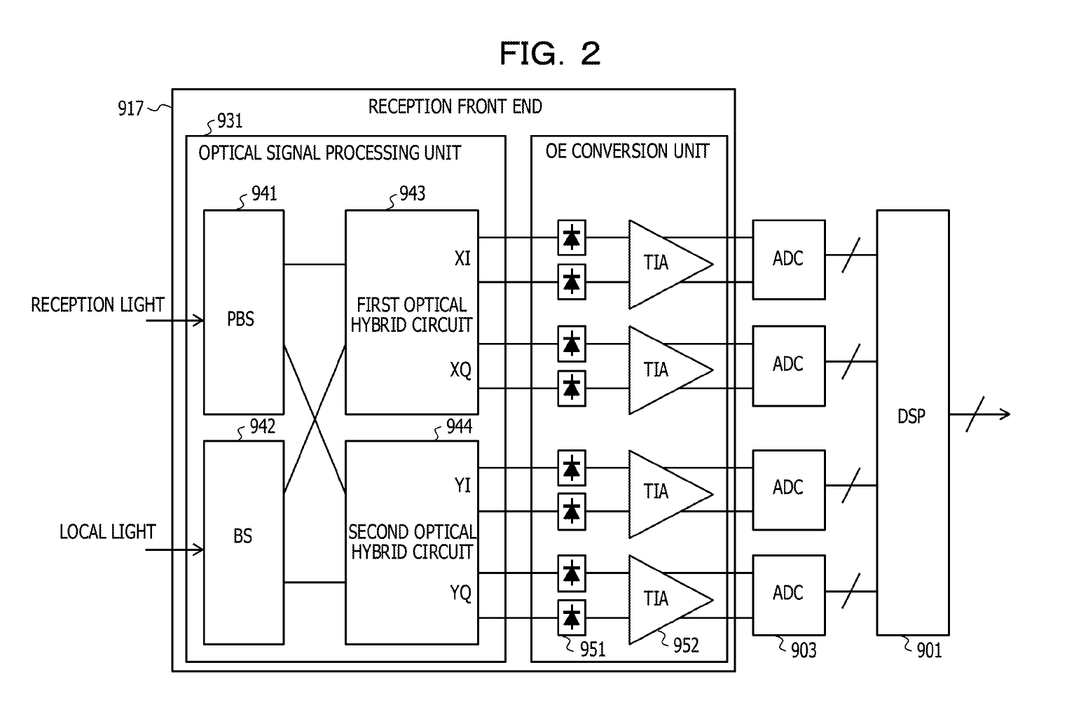

FIG. 2 is an internal block diagram of the reception front end 917.

The reception front end 917 is a planar waveguide formed with a plurality of optical elements and includes, for example, an optical signal processing unit 931 that demodulates reception light modulated by DP-QPSK and an OE conversion unit 932 that converts the optical signal demodulated by the optical signal processing unit into an electric signal.

The optical signal processing unit 931 includes a polarization beam splitter 941, a beam splitter 942, a first optical hybrid circuit 943 and a second optical hybrid circuit 944 which are a pair of optical 90-degree hybrid circuits. The optical signal processing unit 931 divides the input reception light into an I channel phase component XI and a Q channel phase component XQ of an orthogonal X polarization component, and an I channel phase component YI and a Q channel phase component YQ of a Y polarization component orthogonal to an X polarization component. Since the structures and functions of the polarization beam splitter 941, the beam splitter 942, the first optical hybrid circuit 943 and the second optical hybrid circuit 944 are widely known, a detailed description thereof will be omitted here.

The OE conversion unit 932 includes four pairs of photodiodes 951 and four trans-impedance amplifiers (TIA) 952. The OE conversion unit 932 converts the four optical signals XI, XQ, YI, and YQ divided from the reception light by the optical signal processing unit 931 into electric signals and outputs the converted electric signals to the analog-to-digital converter 903. Since the structures and functions of the photodiode 951 and the TIA 952 are widely known, a detailed description thereof will be omitted here.

The digital coherent optical transceiver 900 may be downsized and the power consumption thereof may be reduced by dividing part of the light output from the light source 911 by the beam splitter 913 and using the light as local light. The digital coherent optical transceiver 900 may stop the optical output power of the transmission light from being reduced by the EDFA 916 amplifying the transmission light modulated by the optical modulator 915.

However, since the optical amplifying fiber 923 included in the EDFA 916 has a length of several meters, it is not easy to downsize the digital coherent optical transceiver.

In the optical reception device according to the embodiment, in an optical waveguide substrate having an optical element such as a polarization beam splitter, when excitation light is introduced into at least one of the waveguides through which light passes, the waveguide is doped with rare earth ions that amplify light having a predetermined frequency. In the optical reception device according to the embodiment, by passing excitation light for exciting rare earth ions together with light such as local light passing through the waveguide doped with rare earth ions that amplify light having the predetermined frequency when excitation light is introduced, the passing light is amplified. Since the reception front end according to the embodiment may amplify light such as local light that passes through, by lowering the ratio of the transmission light divided into the local light by the beam splitter, an EDFA may be omitted in the digital coherent optical transceiver. The digital coherent optical transceiver may be reduced in size by omitting a large EDFA.

### Embodiment 1-1

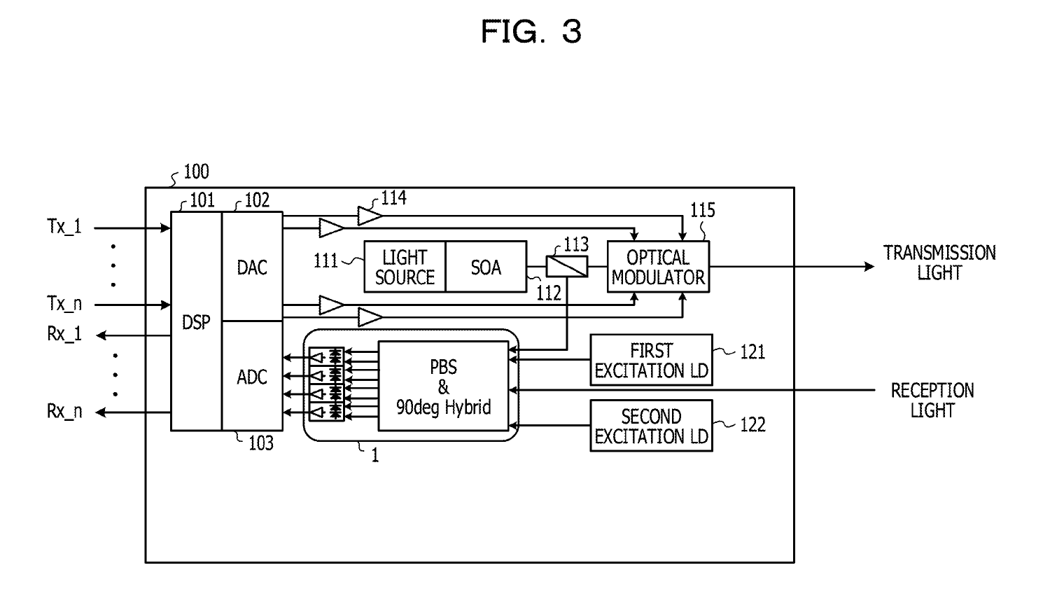

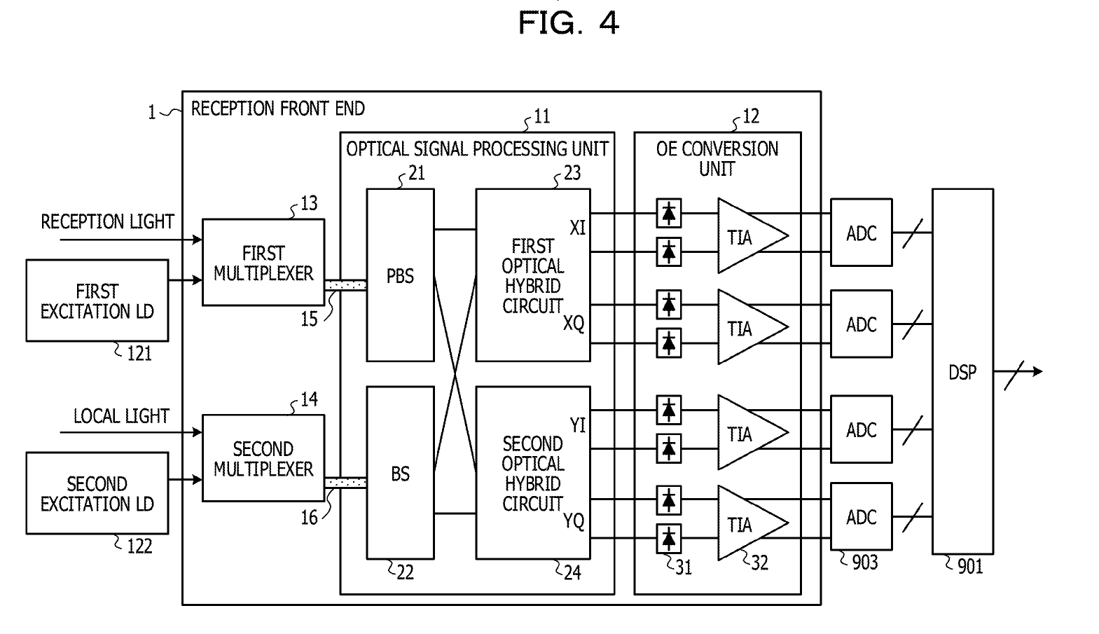

FIG. 3 is a block diagram of a digital coherent optical transceiver including a reception front end 1 which is an example of an optical reception device according to Embodiment 1-1. FIG. 4 is an internal block diagram of the reception front end 1.

The digital coherent optical transceiver 100 includes a DSP 101, a digital-to-analog converter 102, and an analog-to-digital converter 103. The digital coherent optical transceiver 100 further includes a light source 111, an SOA 112, a beam splitter 113, a modulation driver 114, an optical modulator 115, a first excitation laser 121 and a second excitation laser 122, and the reception front end 1.

The configurations and functions of the DSP 101 to the analog-to-digital converter 103 are similar to those of the DSP 901 to the analog-to-digital converter 903. The configurations and functions of the light source 111, the SOA 112, the modulation driver 114, and the optical modulator 115 are similar to those of the light source 911, the SOA 912, the modulation driver 914, and the optical modulator 915. Therefore, the detailed description of the configurations and functions of the DSP 101 to the analog-to-digital converter 103, the light source 111, the SOA 112, the modulation driver 114, and the optical modulator 115 will be omitted here.

The beam splitter 113 is, for example, a pair of prisms having inclined surfaces joined to each other. The beam splitter 113 divides the coherent light amplified by the SOA 112 into two light beams at a predetermined ratio of a ratio of 100:1. The beam splitter 913 outputs the light having the ratio of 100 to the optical modulator 115 and outputs the light having the ratio of 1 to the reception front end 1.

The first excitation laser 121 and the second excitation laser 122 are, for example, a distributed feedback laser, an SG-DBR laser, a ring resonator laser, or the like. The first excitation laser 121 and the second excitation laser 122 generate excitation light for exciting the erbium ions (Er⁺³) in the 0.98 μm band or the 1.48 μm band and outputs the generated excitation light to the reception front end 1. For example, the excitation light is generated by the first excitation laser 121 and the second excitation laser 122 with a P wave component and an S wave component set to 50%, respectively. In one example, the excitation light is introduced into a fiber twisted at 45 degrees, whereby the P wave component and the S wave component are set to 50%, respectively. In another example, the excitation light is introduced into a half-wave plate, whereby the P wave component and the S wave component are set to 50%, respectively. Since the first excitation laser 121 and the second excitation laser 122 generate heat, the first excitation laser 121 and the second excitation laser 122 are preferably arranged outside the reception front end 1.

The reception front end 1 is a planar waveguide which is an optical waveguide substrate on which a plurality of optical elements are formed. The reception front end 1 includes, for example, an optical signal processing unit 11 that demodulates the reception light modulated by DP-QPSK and an OE conversion unit 12 that converts the optical signal demodulated by the optical signal processing unit into an electric signal. The reception front end 1 further includes a first multiplexer 13, a second multiplexer 14, a first doped waveguide 15, and a second doped waveguide 16. The reception front end 1 is, in one example, a quartz-based substrate, and in another example, is a silicon photonics-based substrate that may be manufactured to be one-fiftieth the size of a quartz-based substrate. The first doped waveguide 15 is an example of a first optical waveguide through which reception light passes, and the second doped waveguide 16 is an example of a fourth optical waveguide through which local light passes.

The optical signal processing unit 11 includes a polarization beam splitter 21, a beam splitter 22, a first optical hybrid circuit 23 and a second optical hybrid circuit 24 which are a pair of optical 90-degree hybrid circuits. The OE conversion unit 12 includes four pairs of photodiodes 31 and four trans-impedance amplifiers 32. Since the configurations and functions of the optical signal processing unit 11 and the OE conversion unit 12 are similar to those of the optical signal processing unit 931 and the OE conversion unit 932, a detailed description thereof will be omitted here.

The first multiplexer 13 and the second multiplexer 14 are optical elements, also called optical couplers. The first multiplexer 13 multiplexes the reception light and the excitation light input from the first excitation laser 121 and outputs the multiplexed light to the first doped waveguide 15. The second multiplexer 14 multiplexes the local light and the excitation light input from the first excitation laser 121 and outputs the multiplexed light to the second doped waveguide 16.

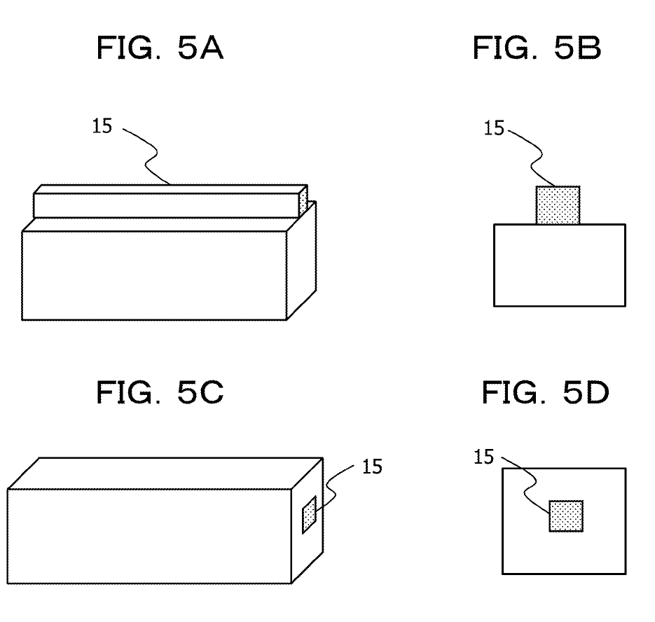

FIG. 5A is a perspective view of an example of the first doped waveguide 15. FIG. 5B is a front view of the first doped waveguide 15 illustrated in FIG. 5A. FIG. 5C is a perspective view of another example of the first doped waveguide 15. FIG. 5D is a front view of the first doped waveguide 15 illustrated in FIG. 5C.

The first doped waveguide 15 is a waveguide type EDFA doped with erbium ions (Er⁺³), also called an EDWA. The first doped waveguide 15 may be a ridge type as illustrated in FIGS. 5A and 5B, or may be an embedded type as illustrated in FIGS. 5C and 5D. The relative refractive index difference of the first doped waveguide 15 is about 0.5% to 1% when the reception front end 1 is a quartz-based substrate and about 35% when the reception front end 1 is a silicon photonics-based substrate.

When the first doped waveguide 15 is a ridge type, the size may be increased and the design is simplified. On the other hand, when the first doped waveguide 15 is an embedded type, the size decreases. The mode field diameter of the first doped waveguide 15 is, for example, 5 μ. Since the mode field diameter of the waveguide in the related art is about 10 μm, the mode field diameter of the first doped waveguide 15 is approximately half of the mode field diameter of the waveguide in the related art. In the first doped waveguide 15, since not only the reception light but also the excitation light which is shorter than the reception light is guided, the mode field diameter is preferably set to about half of the mode field diameter in the related art. The erbium ions (Er⁺³) may be doped into the first doped waveguide 15 during crystal growth. Alternatively, the first doped waveguide 15 may be doped after crystal growth.

Since the second doped waveguide 16 has a structure similar to that of the first doped waveguide 15, a description of the structure of the second doped waveguide 16 will be omitted here.

The reception light is amplified in the first doped waveguide 15 by passing through the first doped waveguide 15 together with the excitation light multiplexed by the first multiplexer 13. The local light is amplified in the second doped waveguide 16 by passing through the second doped waveguide 16 together with the excitation light multiplexed by the second multiplexer 14.

Since the reception front end 1 may amplify the reception light attenuated while passing through a transmission path (not illustrated) in the first doped waveguide 15, the optical amplification characteristics of the reception light may be improved.

The reception front end 1 may amplify the local light in the second doped waveguide 16. Therefore, the reception front end 1 may lower the ratio of the local light divided by the beam splitter 113 and increase the ratio of the light output to the optical modulator 115. The reception front end 1 may increase the ratio of light input to the optical modulator 115. Therefore, in the digital coherent optical transceiver 100, an EDFA that amplifies the transmission light output from the optical modulator 115 may be omitted. Since the digital coherent optical transceiver 100 does not have the EDFA, the digital coherent optical transceiver 100 may be downsized.

### Embodiment 1-2

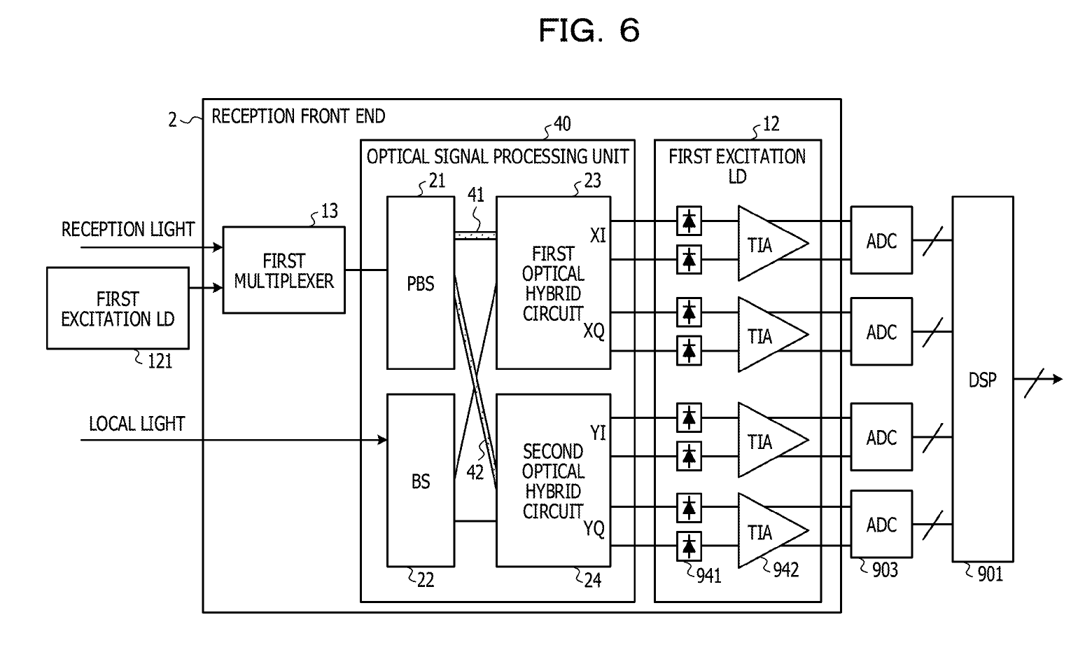

FIG. 6 is an internal block diagram of a reception front end 2 which is an example of an optical reception device according to Embodiment 1-2.

The reception front end 2 is different from the reception front end 1 in that an optical signal processing unit 40 is provided instead of the optical signal processing unit 11. The reception front end 2 is different from the reception front end 1 in that the reception front end 2 does not have the second multiplexer 14, the first doped waveguide 15, and the second doped waveguide 16. Since the configuration and functions of the components of the reception front end 2 other than the optical signal processing unit 40 are the same as those of the components of the reception front end 1 denoted by the same reference numerals, the detailed description thereof will be omitted here.

The optical signal processing unit 40 is different from the optical signal processing unit 11 in that the optical signal processing unit 40 has a first reception light doped waveguide 41 and a second reception light doped waveguide 42. The first reception light doped waveguide 41 connects the polarization beam splitter 21 and the first optical hybrid circuit 23. Then, the second reception light doped waveguide 42 connects the polarization beam splitter 21 and the second optical hybrid circuit 24. The first reception light doped waveguide 41 is an example of a second optical waveguide through which the X polarization component passes. The second reception light doped waveguide 42 is an example of a third optical waveguide through which the Y polarization component passes.

The first reception light doped waveguide 41 and the second reception light doped waveguide 42 are waveguides doped with erbium ions (Er⁺³). The structures of the first reception light doped waveguide 41 and the second reception light doped waveguide 42 have a structure similar to that of the first doped waveguide 15. Therefore, the description of the structures of the first reception light doped waveguide 41 and the second reception light doped waveguide 42 will be omitted here.

The reception light is amplified in the first reception light doped waveguide 41 by passing through the first reception light doped waveguide 41 together with the excitation light multiplexed by the first multiplexer 13. The reception light is amplified in the second reception light doped waveguide 42 by passing through the second reception light doped waveguide 42 together with the excitation light multiplexed by the first multiplexer 13.

The reception front end 2 may amplify the reception light attenuated while passing through a transmission path (not illustrated) in the first reception light doped waveguide 41 and the second reception light doped waveguide 42. Therefore, the reception front end 2 may improve the optical amplification characteristics of the reception light.

The reception front end 2 sets the P wave component and the S wave component of the excitation light generated by the first excitation laser 121 and the second excitation laser 122 respectively to 50% so that the excitation light reaches the first reception light doped waveguide 41 and the second reception light doped waveguide 42 without loss.

### Embodiment 1-3

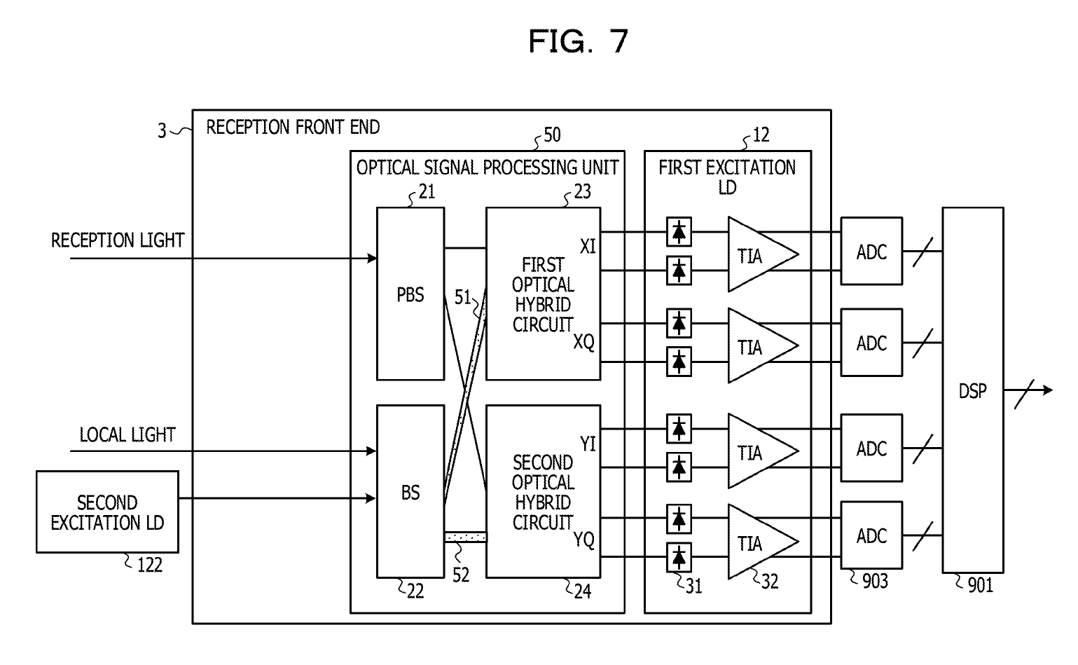

FIG. 7 is an internal block diagram of a reception front end 3 which is an example of an optical reception device according to Embodiment 1-3.

The reception front end 3 is different from the reception front end 1 in that an optical signal processing unit 50 is provided instead of the optical signal processing unit 11. The reception front end 3 is different from the reception front end 1 in that the reception front end 3 does not have the first multiplexer 13, the second multiplexer 14, the first doped waveguide 15, and the second doped waveguide 16. The configuration and functions of the components of the reception front end 3 other than the optical signal processing unit 50 are the same as those of the components of the reception front end 1 denoted by the same reference numerals. Therefore, a detailed description will be omitted here.

The optical signal processing unit 50 differs from the optical signal processing unit 11 in that the optical signal processing unit 50 has a first local light doped waveguide 51 and a second local light doped waveguide 52. The first local light doped waveguide 51 connects the beam splitter 22 and the first optical hybrid circuit 23. The second local light doped waveguide 52 connects the beam splitter 22 and the second optical hybrid circuit 24. The first local light doped waveguide 51 and the second local light doped waveguide 52 are examples of a fourth optical waveguide through which local light passes.

The first local light doped waveguide 51 and the second local light doped waveguide 52 are waveguides doped with erbium ions (Er⁺³). The structures of the first local light doped waveguide 51 and the second local light doped waveguide 52 have the same structure as that of the first doped waveguide 15. Therefore, the structures of the first local light doped waveguide 51 and the second local light doped waveguide 52 will not be described here.

The local light is amplified in the first local light doped waveguide 51 by passing through the first local light doped waveguide 51 together with the excitation light multiplexed by the beam splitter 22. The local light is amplified in the second local light doped waveguide 52 by passing through the second local light doped waveguide 52 together with the excitation light multiplexed by the beam splitter 22.

The reception front end 3 amplifies the local light in the first local light doped waveguide 51 and the second local light doped waveguide 52. Therefore, the ratio of the local light divided by the beam splitter 113 may be lowered, and the ratio of the light output to the optical modulator 115 may be increased. The reception front end 3 may increase the ratio of the light input to the optical modulator 115. Therefore, in the digital coherent optical transceiver on which the reception front end 3 is mounted, it is possible to omit the EDFA that amplifies the transmission light output from the optical modulator 115. The digital coherent optical transceiver on which the reception front end 3 is mounted does not have the EDFA, thus digital coherent optical transceiver may be downsized.

In the reception front end 3, since the local light and the excitation light are multiplexed by the beam splitter 22, the second multiplexer 14 arranged at the reception front end 1 may be omitted.

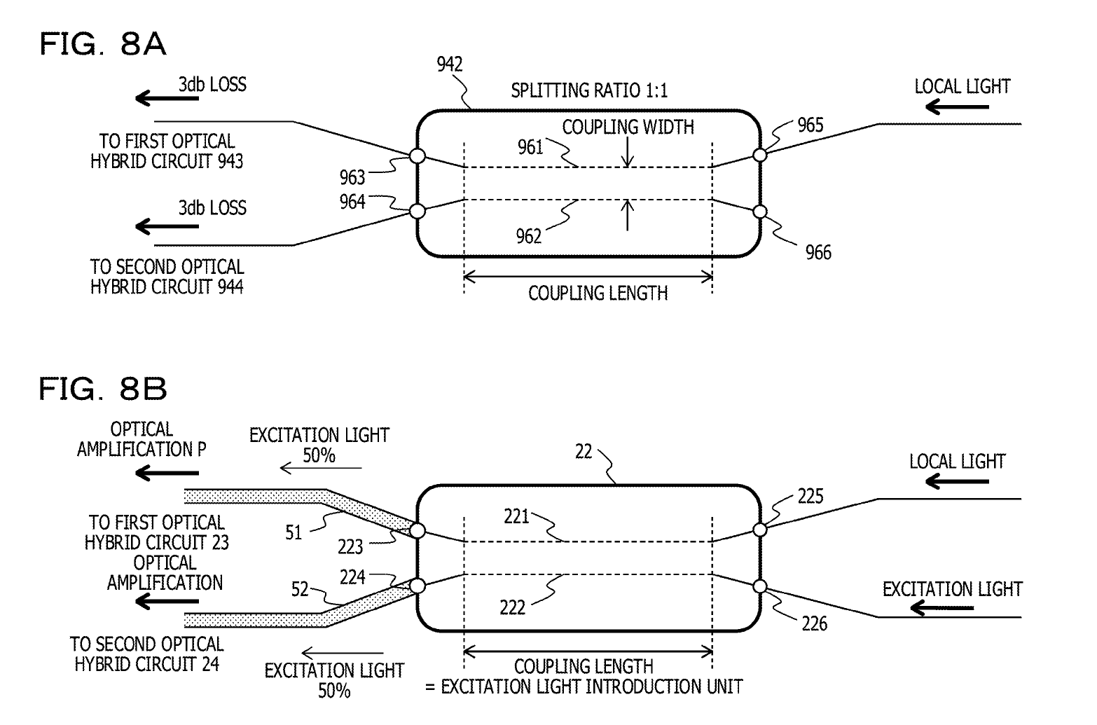

FIG. 8A is a diagram for describing the operation of the beam splitter 942. FIG. 8B is a diagram for describing an operation of the beam splitter 22 of the reception front end 3.

The beam splitter 942 includes a first waveguide 961, a second waveguide 962, a first port 963, a second port 964, a third port 965, and a fourth port 966. The first port 963 is arranged at one end of the first waveguide 961. The second port 964 is arranged at one end of the second waveguide 962. The third port 965 is arranged at the other end of the first waveguide 961. The fourth port 966 is arranged at the other end of the second waveguide 962. The splitting ratio of the beam splitter 942 is, for example, 1:1. The beam splitter 942 attenuates the local light introduced from the third port 965 by 3 dB and outputs the attenuated light to the first optical hybrid circuit 943 and the second optical hybrid circuit 944 via the first port 963 and the second port 964.

The beam splitter 22 includes a first waveguide 221, a second waveguide 222, a first port 223, a second port 224, a third port 225, and a fourth port 226. The first port 223 is arranged at one end of the first waveguide 221. The second port 224 is arranged at one end of the second waveguide 222. The third port 225 is arranged at the other end of the first waveguide 221. The fourth port 226 is arranged at the other end of the second waveguide 222. The splitting ratio of the beam splitter 22 is, for example, 1:1.

In the beam splitter 22, the local light is introduced from the third port 225 and the excitation light is introduced from the other side of the fourth port 226. The beam splitter 22 combines the introduced local light and excitation light. Then, the beam splitter 22 divides the combined light into halves and outputs the divided light to the first local light doped waveguide 51 and the second local light doped waveguide 52 via the first port 223 and the second port 224. The first local light doped waveguide 51 and the second local light doped waveguide 52 amplify the input light and output the amplified light to the first optical hybrid circuit 23 and the second optical hybrid circuit 24.

As illustrated in FIG. 8B, the reception front end 3 multiplexes the local light and the excitation light at the beam splitter 22. Therefore, the second multiplexer 14 arranged at the reception front end 1 may be omitted.

### Embodiment 1-4

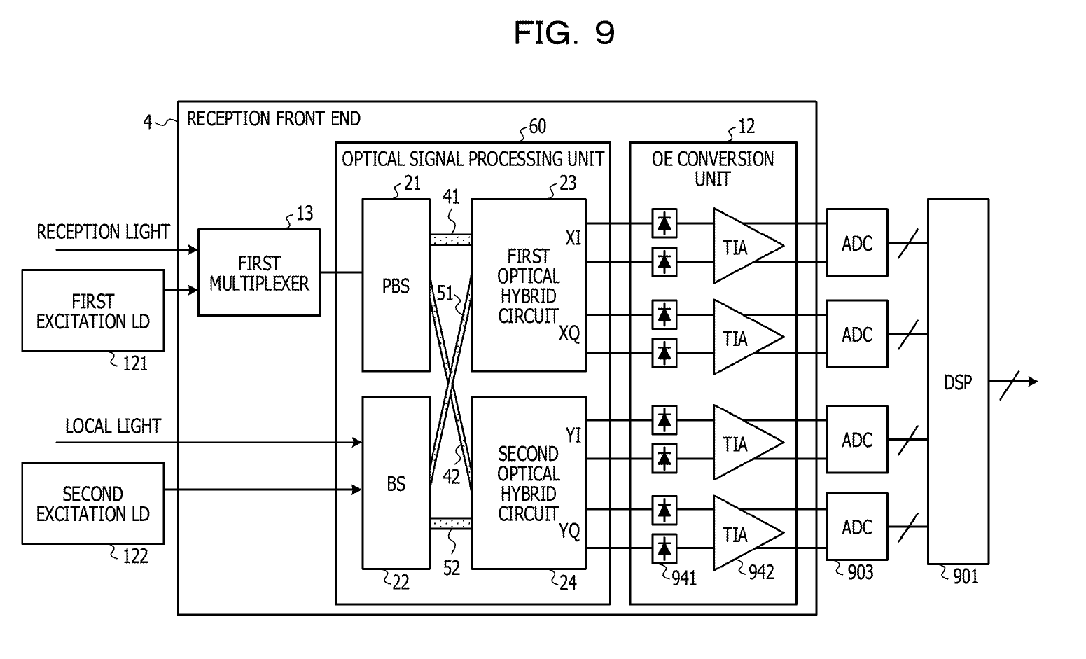

FIG. 9 is an internal block diagram of a reception front end 4 which is an example of an optical reception device according to Embodiment 1-4.

The reception front end 4 is different from the reception front end 1 in that an optical signal processing unit 60 is provided instead of the optical signal processing unit 11. The reception front end 4 is different from the reception front end 1 in that the reception front end 4 does not have the second multiplexer 14, the first doped waveguide 15, and the second doped waveguide 16. Since the configuration and functions of the components of the reception front end 4 other than the optical signal processing unit 60 are the same as those of the components of the reception front end 1 denoted by the same reference numerals, the detailed description thereof will be omitted here.

The optical signal processing unit 60 differs from the optical signal processing unit 11 in that the optical signal processing unit 60 has the first reception light doped waveguide 41, the second reception light doped waveguide 42, the first local light doped waveguide 51, and the second local light doped waveguide 52. Since the first local light doped waveguide 51 and the second local light doped waveguide 52 have been described with reference to FIG. 7, a detailed description thereof will be omitted here.

The reception front end 4 may amplify the reception light attenuated while passing through a transmission path (not illustrated) in the first reception light doped waveguide 41 and the second reception light doped waveguide 42. Therefore, the optical amplification characteristics of the reception light may be improved.

The reception front end 4 amplifies the local light in the first local light doped waveguide 51 and the second local light doped waveguide 52. Therefore, the ratio of the local light divided by the beam splitter 113 may be lowered, and the ratio of the light output to the optical modulator 115 may be increased. The reception front end 4 may increase the ratio of the light input to the optical modulator 115. Therefore, in the digital coherent optical transceiver on which the reception front end 4 is mounted, it is possible to omit an EDFA that amplifies the transmission light output from the optical modulator 115. The digital coherent optical transceiver on which the reception front end 4 is mounted does not have the EDFA, thus digital coherent optical transceiver may be downsized.

In the reception front end 4, the local light and the excitation light are multiplexed by the beam splitter 22. Therefore, the second multiplexer 14 arranged at the reception front end 1 may be omitted.

Table 1 illustrates a comparison between the optical reception device according to the embodiment and another technique. In Table 1, EDFA illustrates the characteristics when light is amplified by an EDFA. SOA illustrates the characteristics when light is amplified by an SOA. EDWA illustrates the characteristics of the optical reception device according to the embodiment.

TABLE 1

| | EDFA | SOA | EDWA |
|---|---|---|---|
| Optical Gain Characteristics | Very | Very | Very |
| | Good | Good | Good |
| NF Characteristics | Very | Moderate | Very |
| | Good | | Good |
| Efficiency | Very | Good | Very |
| | Good | | Good |
| Size | Not | Very | Good |
| | Good | Good | |
| Application Position | Very | Not | Very |
| Flexibility | Good | Good | Good |

When light is amplified by an EDFA, optical gain characteristics, NF characteristics, efficiency, and flexibility are very good. However, since the EDFA has an optical fiber having a length of several meters, there is a problem that the size is increased. When light is amplified by an SOA, the optical gain characteristics are very good and downsizing is possible. However, an SOA has a problem that it is not preferable to use an SOA for amplifying an optical signal modulated by a modulator because a waveform deteriorates due to a pattern effect.

Since the optical reception device according to the embodiment for amplifying light by an EDWA is a digital coherent optical receiver which amplifies only one frequency band, the optical gain characteristics are improved. Since the optical reception device according to the embodiment may be set so as to have the reception performance of the wavelength selection according to the coherent local light generated by the first multiplexer 13 and the second multiplexer 14, the influence of noise light is minor. Since the optical reception device according to Embodiments 1-2 to 1-4 has a structure in which a plurality of optical paths are amplified with a single excitation light source without actual insertion loss, the excitation efficiency is improved. In the optical reception device according to Embodiment 1-3 and Embodiment 1-4, the local light and the excitation light are multiplexed by using the surplus port of the beam splitter 22, a multiplexer such as a WDM coupler is optional. In the optical reception device according to the embodiment, since a waveguide type EDFA doped with erbium ions (Er⁺³) is integrated with the reception front end which is manufactured of a waveguide as a digital coherent optical receiver, the flexibility is high.

Modification Example of Optical Reception Device

In the reception front ends 1 to 4, a waveguide type EDFA doped with erbium ions (Er⁺³) is used, but in the optical reception device according to the embodiment, a waveguide type EDFA doped with another rare earth ion such as praseodymium ion (Pr⁺³) may be used.

In the reception front end 1, the first multiplexer 13 and the second multiplexer 14 are arranged. However, in the optical reception device according to the embodiment, either one of the first multiplexer 13 and the second multiplexer 14 may be arranged.

Next, an optical modulator and an optical modulation method according to the embodiment will be described.

Before describing the optical modulator and the optical modulation method according to the embodiment, an optical modulator related to the optical modulator according to the embodiment will be described.

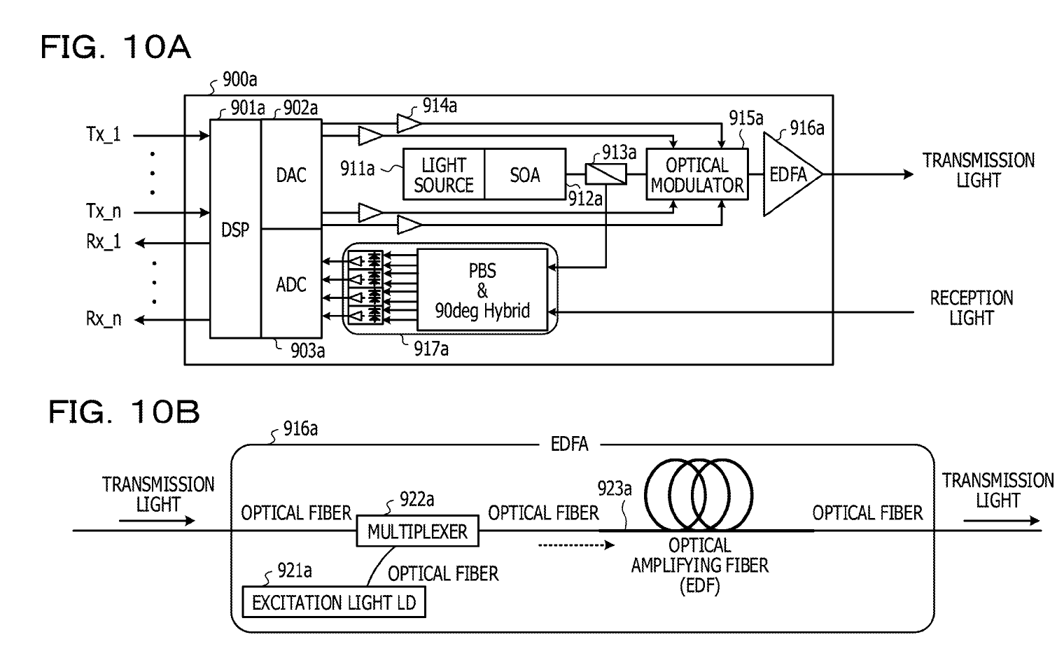

FIG. 10A is a block diagram of a digital coherent optical transceiver including an associated optical modulator. FIG. 10B is an internal block diagram of an EDFA illustrated in FIG. 10A.

A digital coherent optical transceiver 900a includes a digital signal processor (DSP) 901a, a digital-to-analog converter 902a, and an analog-to-digital converter 903a. The digital coherent optical transceiver 900a further includes a light source 911a, a semiconductor optical amplifier (SOA) 912a, a beam splitter 913a, a modulation driver 914a, an optical modulator 915a, and an EDFA 916a. The digital coherent optical transceiver 900a further includes a reception front end 917a.

The DSP 901a receives digital transmission signals Tx1 to Tx_n and executes a predetermined process on the data corresponding to the input digital transmission signals Tx1 to Tx_n to output a digital transmission signal indicating data that has undergone the predetermined process to the digital-to-analog converter 902a. The DSP 901a receives a digital reception signal from the analog-to-digital converter 903a and executes a predetermined process on the data corresponding to the input digital reception signal to output digital reception signals Rx1 to Rx_n indicating data that has undergone a predetermined process. The digital-to-analog converter 902a performs digital-to-analog conversion on the digital transmission signal input from the DSP 901a to generate an analog transmission signal and outputs the generated analog transmission signal to the modulation driver 914a. The analog-to-digital converter 903a performs analog-to-digital conversion on the analog reception signal input from the reception front end 917a to generate a digital transmission signal and outputs the generated digital reception signal to the DSP 901a.

The light source 911a is, for example, a distributed feedback (DFB) laser, a sampled grating-distributed bragg reflector (SG-DBR) laser, a ring resonator laser, or the like, and a laser that outputs coherent light having desired optical characteristics. The coherent light output from the light source 911a is, for example, light in a 1.55 μm band.

The SOA 912a is formed of a semiconductor material such as GaAs and AlGaAs and is an amplifier that amplifies coherent light input from the light source 911a. The beam splitter 913a is, for example, a pair of prisms joining mutually inclined planes and divides the coherent light amplified by the SOA 912a into two light beams at a predetermined ratio of a ratio of 1:1. The beam splitter 913a outputs one of the divided light beams to the optical modulator 915a and outputs the other divided light beam to the reception front end 917a. The modulation driver 914a outputs the analog transmission signal input from the digital-to-analog converter 902a to the optical modulator 915a. The optical modulator 915a outputs modulation light obtained by modulating the coherent light output from the light source 911a to the EDFA 916a based on the analog transmission signal input via the modulation driver 914a. Since the structures and functions of the SOA 912a, the beam splitter 913a, and the modulation driver 914a are widely known, a detailed description thereof will be omitted here. The optical modulator 915a is formed of, for example, a planar lightwave circuit (PLC) and an LN element and performs quaternary phase-shift keying modulation on the coherent light (QPSK) to generate modulation light.

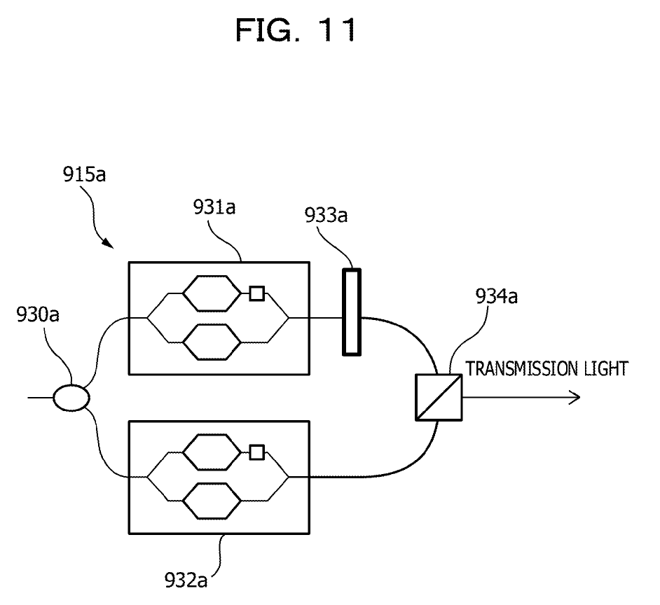

FIG. 11 is an internal block diagram of the optical modulator 915a.

The optical modulator 915a includes a beam splitter 930a, a first QPSK circuit 931a, a second QPSK circuit 932a, a polarization rotator 933a, and a polarization beam combiner (PBC) 934a. The beam splitter 930a divides the light input from the beam splitter 913a in a one-to-one manner and outputs the divided light to the first QPSK circuit 931a and the second QPSK circuit 932a, respectively. Each of the first QPSK circuit 931a and the second QPSK circuit 932a performs quaternary phase-shift keying modulation on the light input from the beam splitter 930a. The first QPSK circuit 931a outputs the light modulated by quaternary phase-shift keying to the polarization rotator 933a, and the second QPSK circuit 932a outputs the light modulated by quaternary phase-shift keying to the PBC 934a. The polarization rotator 933a polarizes the light input from the first QPSK circuit 931a by 90 degrees and outputs the polarized light to the PBC 934a. The PBC 934a multiplexes the light input from the second QPSK circuit 932a and the polarization rotator 933a, respectively and outputs the multiplexed light to the EDFA 916a. Since the structures and functions of the beam splitter 930a, the first QPSK circuit 931a, the second QPSK circuit 932a, the polarization rotator 933a, and the PBC 934a are widely known, a detailed description thereof will be omitted here.

The EDFA 916a includes an excitation light laser 921a, a multiplexer 922a, and an optical amplifying fiber 923a. The excitation light laser 921a is, for example, a distributed feedback laser, an SG-DBR laser, a ring resonator laser or the like and generates excitation light for exciting the erbium ions (Er⁺³) in a 0.98 μm band or a 1.48 μm band and outputs the generated excitation light to the multiplexer 922a. The multiplexer 922a is, for example, a WDM coupler and multiplexes the modulation light input from the optical modulator 915a and the excitation light input from the excitation light laser 921a and outputs the multiplexed light to the optical amplifying fiber 923a. The optical amplifying fiber 923a is, for example, an optical fiber having a length of several meters doped with erbium ions (Er⁺³) as a core. The optical amplifying fiber 923a is an amplifier that amplifies light in a 1.55 μm band when the excitation light is input from the excitation light laser 921a. The reception front end 917a is a planar waveguide formed with a plurality of optical elements. The reception front end 917a demodulates the reception light modulated by QPSK, for example, and converts the demodulated optical signal into an electric signal.

The digital coherent optical transceiver 900a may be downsized and the power consumption thereof may be reduced by dividing part of the light output from the light source 911a by the beam splitter 913a and using the light as local light. The digital coherent optical transceiver 900a may stop the optical output power of the transmission light from being reduced by the EDFA 916a amplifying the transmission light modulated by the optical modulator 915a.

However, since the optical amplifying fiber 923a included in the EDFA 916a has a length of several meters, it is not easy to downsize the digital coherent optical transceiver.

The optical modulator according to the embodiment includes a demultiplexing unit that demultiplexes input light into at least two light beams, a modulation unit that modulates the light demultiplexed by the demultiplexing unit, and a light multiplexing unit that multiplexes the light modulated by the modulation unit and outputs the multiplexed light as transmission light. The multiplexing unit of the optical modulator according to the embodiment includes an optical waveguide doped with rare earth ions for amplifying light having a predetermined frequency and an introduction port that introduces excitation light for exciting rare earth ions in the optical waveguide. By having such a configuration, the optical modulator according to the embodiment may share an optical amplification function together with an optical modulation function. Since the optical modulator according to the embodiment may share the optical modulation function and the optical amplification function, the EDFA may be omitted in the digital coherent optical transceiver. The digital coherent optical transceiver may be reduced in size by omitting a large EDFA.

### Embodiment 2-1

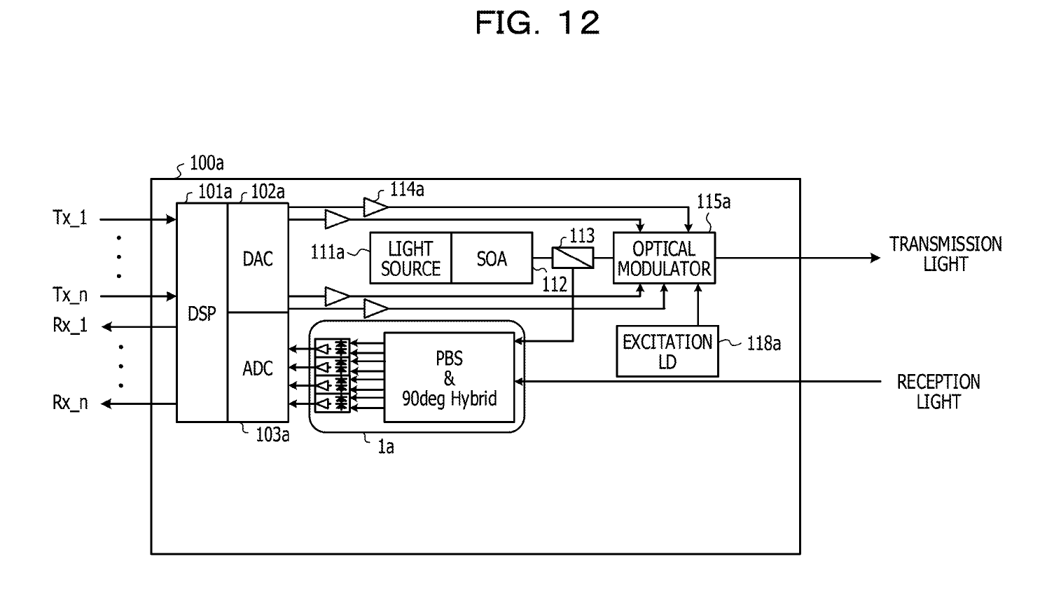

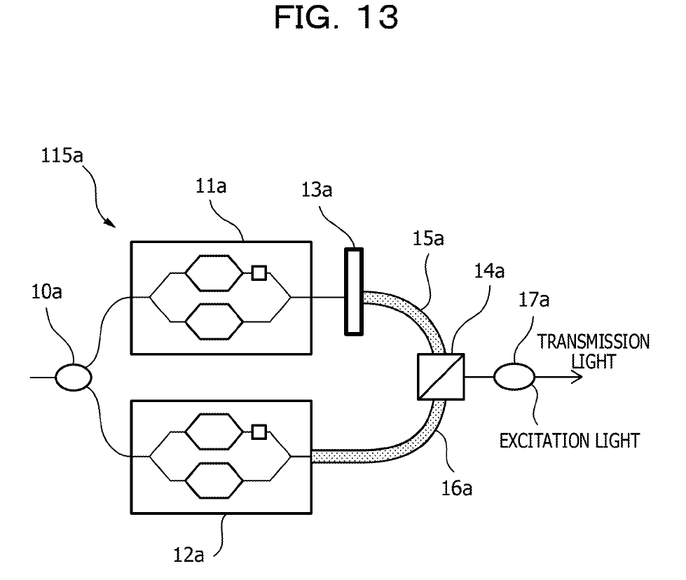

FIG. 12 is a block diagram of a digital coherent optical transceiver including the optical modulator 115a according to Embodiment 2-1, and FIG. 13 is an internal block diagram of the optical modulator 115a.

The digital coherent optical transceiver 100a includes a DSP 101a, a digital-to-analog converter 102a, and an analog-to-digital converter 103a. The digital coherent optical transceiver 100a further includes a light source 111a, an SOA 112a, a beam splitter 113a, a modulation driver 114a, an optical modulator 115a, a reception front end 1a, and an excitation laser 118a.

The configurations and functions of the DSP 101a to the analog-to-digital converter 103a are similar to those of the DSP 901a to the analog-to-digital converter 903a. The configuration and functions of the light source 111a, the SOA 112a, the modulation driver 114a, and the reception front end 1a are similar to those of the light source 911a, the SOA 912a, the modulation driver 914a, and the reception front end 917a. Therefore, a detailed description of the configurations and functions of the DSP 101a to the analog-to-digital converter 103a, the light source 111a, the SOA 112a, the modulation driver 114a, and the reception front end 1a will be omitted here.

The beam splitter 113a is, for example, a pair of prisms joining mutually inclined planes and divides the coherent light amplified by the SOA 112a into two light beams at a predetermined ratio of a ratio of 100:1. The beam splitter 913a outputs the light having the ratio of 1 to the optical modulator 115a and outputs the light having the ratio of 100 to the reception front end 1a.

The excitation laser 118a is, for example, a distributed feedback laser, an SG-DBR laser, a ring resonator laser, or the like. The excitation laser 118a generates excitation light for exciting the erbium ions (Er⁺³) in the 0.98 μm band or the 1.48 μm band and outputs the generated excitation light to the optical modulator 115a. For the excitation light generated by the excitation laser 118a, for example, the P wave component and the S wave component are set to 50%, respectively. In one example, the excitation light is introduced into a fiber twisted at 45 degrees, whereby the P wave component and the S wave component are set to 50%, respectively. In another example, the excitation light is introduced into a half-wave plate, whereby the P wave component and the S wave component are set to 50%, respectively. Since the excitation laser 118a generates heat, the excitation laser 118a is preferably arranged outside the optical modulator 115a.

The optical modulator 115a includes a beam splitter 10a, a first QPSK circuit 11a, a second QPSK circuit 12a, a polarization rotator 13a, a PBC 14a, a first doped waveguide 15a, a second doped waveguide 16a, and an optical directional coupler 17a. The beam splitter 10a is a demultiplexing unit that demultiplexes input light into at least two light beams. In the beam splitter 10a, the first QPSK circuit 11a, the second QPSK circuit 12a, and the polarization rotator 13a are modulation units that modulate the light demultiplexed by the demultiplexing unit. The PBC 14a, the first doped waveguide 15a, the second doped waveguide 16a, and the optical directional coupler 17a are multiplexing units that multiplex the light modulated by the modulation unit and output the multiplexed light as transmission light.

The beam splitter 10a divides the light input from the beam splitter 14a in a one-to-one manner and outputs the divided light to the first QPSK circuit 11a and the second QPSK circuit 12a, respectively. Each of the first QPSK circuit 11a and the second QPSK circuit 12a performs quaternary phase-shift keying modulation on the light input from the beam splitter 10a. The first QPSK circuit 11a outputs the light modulated by quaternary phase-shift keying to the polarization rotator 13a. The second QPSK circuit 932a outputs the light modulated by quaternary phase-shift keying to the PBC 14a via the first doped waveguide 15a.

The polarization rotator 13a polarizes the light input from the first QPSK circuit 11a by 90 degrees and outputs the polarized light to the PBC 14a via the first doped waveguide 15a. The PBC 14a multiplexes the light input from the second QPSK circuit 12a and the polarization rotator 13a, respectively and outputs the multiplexed light to the EDFA 916a.

Since the structures and functions of the beam splitter 10a, the first QPSK circuit 11a, the second QPSK circuit 12a, the polarization rotator 13a, and the PBC 14a are widely known, a detailed description thereof will be omitted here.

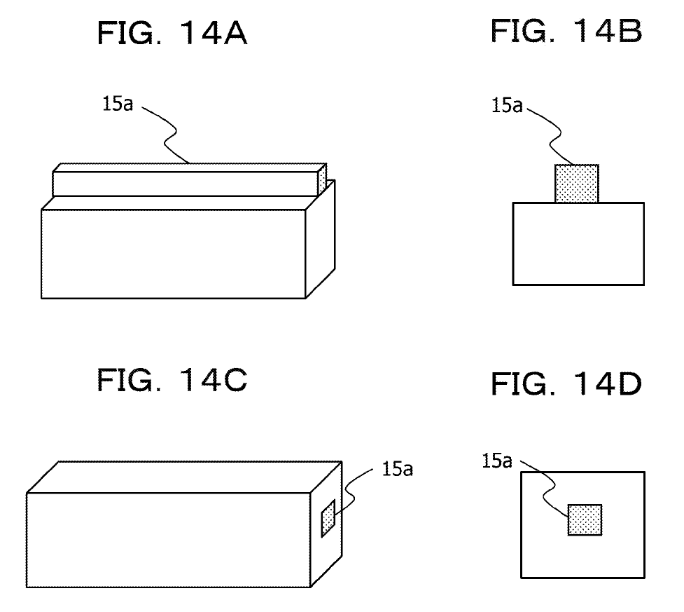

FIG. 14A is a perspective view of an example of the first doped waveguide 15a. FIG. 14B is a front view of the first doped waveguide 15a illustrated in FIG. 14A. FIG. 14C is a perspective view of another example of the first doped waveguide 15a. FIG. 14D is a front view of the first doped waveguide 15a illustrated in FIG. 14C.

The first doped waveguide 15a is a waveguide type EDFA doped with erbium ions (Er⁺³), also called an EDWA. The first doped waveguide 15a may be a ridge type as illustrated in FIGS. 14A and 14B, or may be an embedded type as illustrated in FIGS. 14C and 14D. The relative refractive index difference of the first doped waveguide 15a is about 0.5% to 1% when the optical modulator 115a is a quartz-based substrate and about 35% when the optical modulator 115a is a silicon photonics-based substrate.

When the first doped waveguide 15a is a ridge type, the size may be increased and the design is simplified. On the other hand, when the first doped waveguide 15a is an embedded type, the size decreases. The mode field diameter of the first doped waveguide 15a is, for example, 5 μm. The mode field diameter of the waveguide in the related art is about 10 μm. Therefore, the mode field diameter of the first doped waveguide 15a is approximately half of the mode field diameter of the waveguide in the related art. In the first doped waveguide 15a, since not only the reception light but also the excitation light which is shorter than the reception light is guided, the mode field diameter is preferably set to about half of the mode field diameter in the related art. The erbium ions (Er⁺³) may be doped in the first doped waveguide 15a during crystal growth and may be doped in the first doped waveguide 15a after crystal growth.

Since the second doped waveguide 16a has a structure similar to that of the first doped waveguide 15a, a description of the structure of the second doped waveguide 16a will be omitted here.

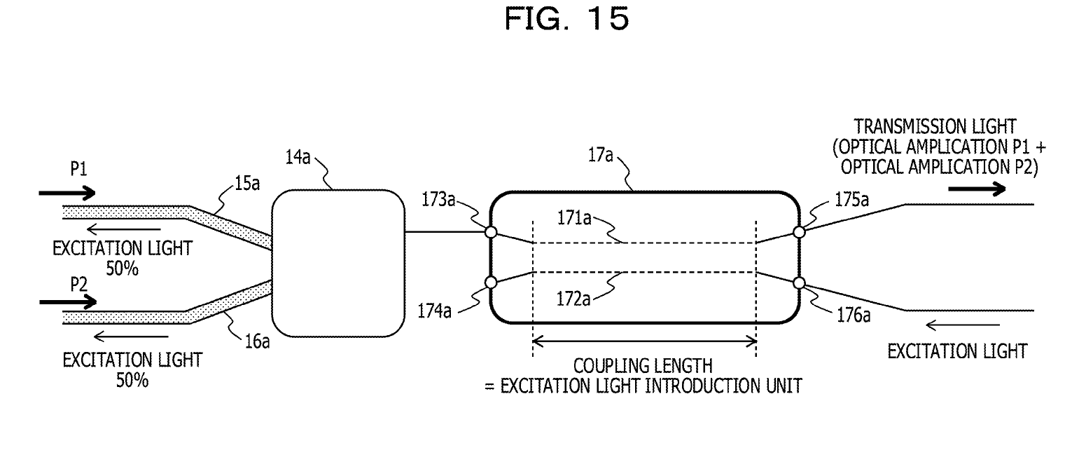

FIG. 15 is a diagram for describing an operation of the first doped waveguide 15a, the second doped waveguide 16a, and the optical directional coupler 17a.

The optical directional coupler 17a includes a first waveguide 171a, a second waveguide 172a, a first port 173a, a second port 174a, a third port 175a, and a fourth port 176a. The first port 173a is arranged at one end of the first waveguide 171a. The second port 174a is arranged at one end of the second waveguide 172a. The third port 175a is arranged at the other end of the first waveguide 171a. The fourth port 176a is arranged at the other end of the second waveguide 172a.

The first port 173a is connected to the PBC 14a, the third port 175a transmits the transmission light, and the fourth port 176a receives the excitation light generated by the excitation laser 118a. 50% of the excitation light input from the fourth port 176a is introduced into the first doped waveguide 15a and the second doped waveguide 16a via the first port 173a and the PBC 14a, respectively. The first doped waveguide 15a and the second doped waveguide 16a function as amplifiers that amplify light P1 and P2 output from the first QPSK circuit 11a and the second QPSK circuit 12a by introducing the excitation light.

The light P1 output from the first QPSK circuit 11a is amplified by the first doped waveguide 15a. The light P1 output from the second QPSK circuit 12a is amplified in the second doped waveguide 16a.

Since the optical modulator 115a uses the light amplified in the first doped waveguide 15a and the second doped waveguide 16a as transmission light, in the digital coherent optical transceiver 100a, an EDFA that amplifies the transmission light output from the optical modulator 115a may be omitted. In the digital coherent optical transceiver 100a, since the EDFA may be omitted, the digital coherent optical transceiver 100a may be downsized.

### Embodiment 2-2

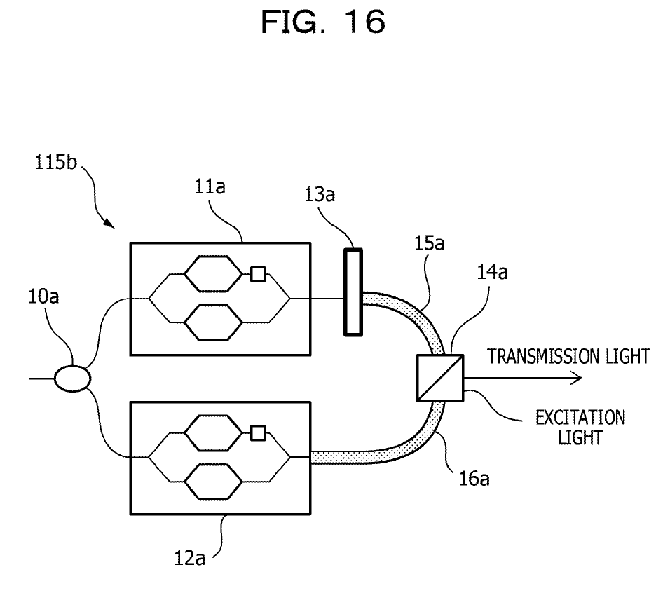

FIG. 16 is an internal block diagram of an optical modulator 115b according to Embodiment 2-2.

The optical modulator 115b is different from the optical modulator 115a in that the optical modulator 115b does not have the optical directional coupler 17a. The optical modulator 115b differs from the optical modulator 115a in that the excitation light generated by the excitation laser 118a is input to the PBC 14a. Since the configuration and functions of the components of the optical modulator 115b other than the PBC 14a are the same as those of the components of the optical modulator 115a denoted by the same reference numerals, the detailed description thereof will be omitted here.

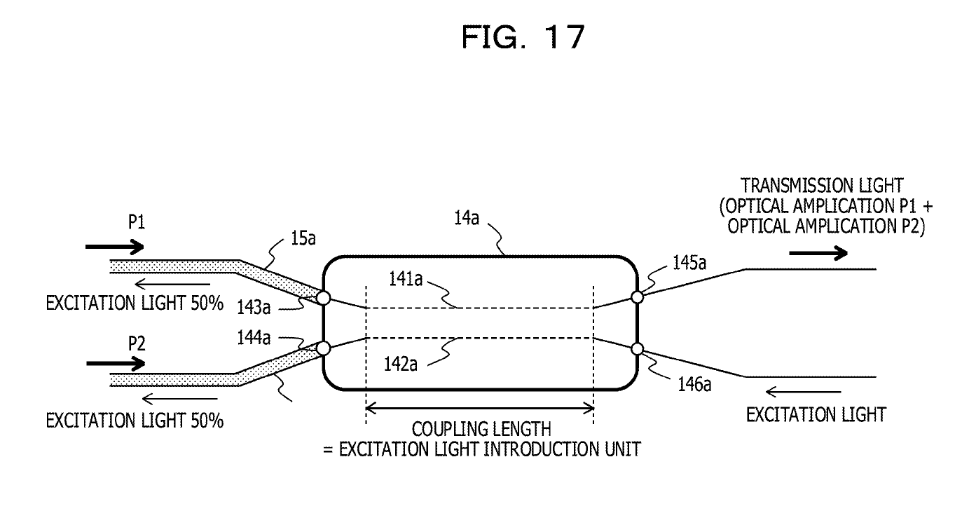

FIG. 17 is a diagram for describing an operation of the first doped waveguide 15a, the second doped waveguide 16a, and the PBC 14a.

The PBC 14a includes a first waveguide 141a, a second waveguide 142a, a first port 143a, a second port 144a, a third port 145a, and a fourth port 146a. The first port 143a is arranged at one end of the first waveguide 141a. The second port 144a is arranged at one end of the second waveguide 142a. The third port 145a is arranged at the other end of the first waveguide 141a. The fourth port 146a is arranged at the other end of the second waveguide 142a.

The first port 143a is connected to the first doped waveguide 15a. The second port 144a is connected to the second doped waveguide 16a. The third port 145a outputs transmission light. The fourth port 146a receives the excitation light generated by the excitation laser 118a. 50% of the excitation light input from the fourth port 146a is introduced to the first doped waveguide 15a and the second doped waveguide 16a via the first port 173a, respectively. The first doped waveguide 15a and the second doped waveguide 16a function as amplifiers that amplify light P1 and P2 output from the first QPSK circuit 11a and the second QPSK circuit 12a by introducing the excitation light.

The optical modulator 115b may cause the first doped waveguide 15a and the second doped waveguide 16a to function as amplifiers without adding a new element by introducing the excitation light via the fourth port 146a which is a surplus port of the PBC 14a.

### Embodiment 2-3

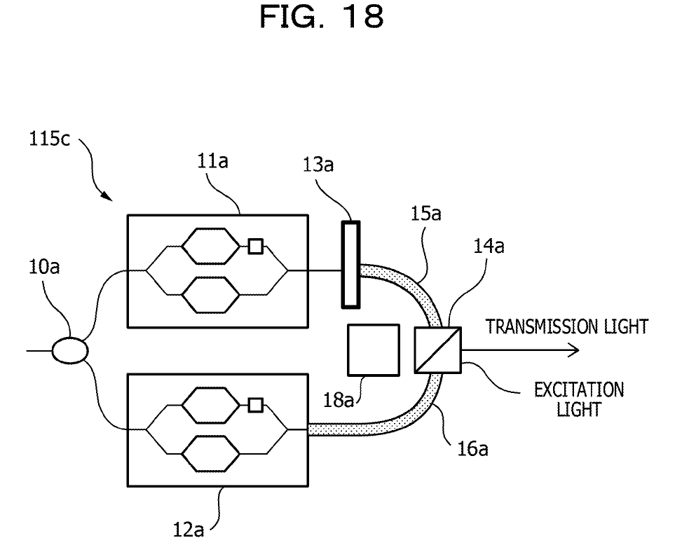

FIG. 18 is an internal block diagram of an optical modulator 115c according to Embodiment 2-3.

The optical modulator 115c differs from the optical modulator 115b in that the optical modulator 115c has a radiation light detection sensor 18a. Since the configuration and functions of the components of the optical modulator 115c other than the radiation light detection sensor 18a are the same as those of the components of the optical modulator 115b denoted by the same reference numerals, the detailed description thereof will be omitted here.

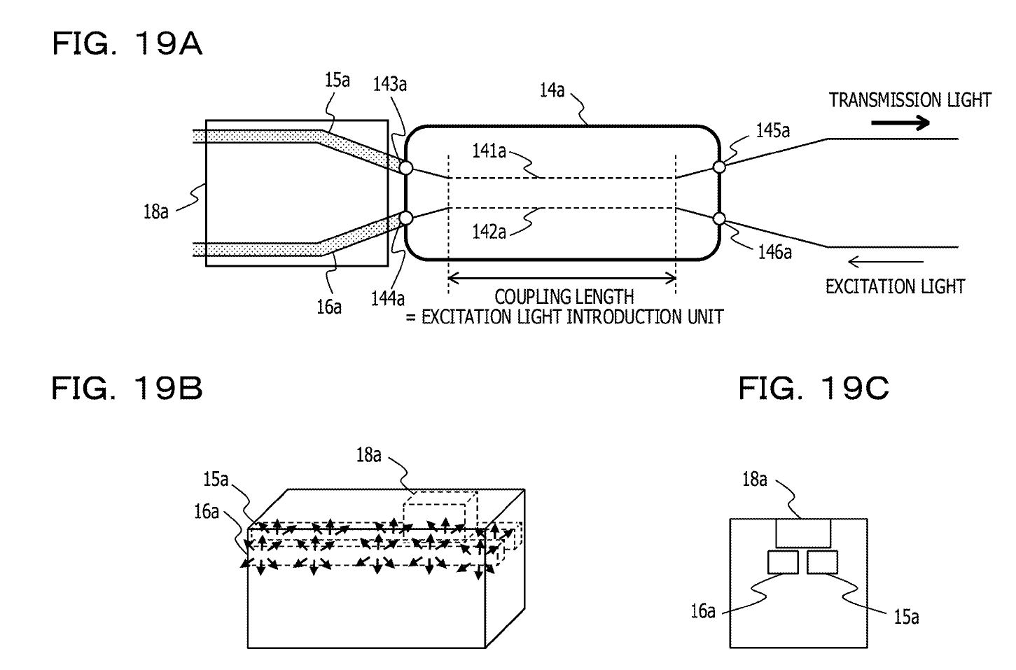

FIG. 19A is a diagram illustrating an arrangement relationship between the first doped waveguide 15a and the second doped waveguide 16a, and the radiation light detection sensor 18a. FIG. 19B is a schematic perspective view of the first doped waveguide 15a, the second doped waveguide 16a, and the radiation light detection sensor 18a. FIG. 19C is a sectional view including the first doped waveguide 15a, the second doped waveguide 16a, and the radiation light detection sensor 18a.

The radiation light detection sensor 18a is, for example, a photodiode. The radiation light detection sensor 18a is arranged to cover both the first doped waveguide 15a and the second doped waveguide 16a and detects the radiation light radiated from the first doped waveguide 15a and the second doped waveguide 16a.

The radiation light detection sensor 18a outputs the intensity of the detected radiation light to a gain control unit (not illustrated). Then, the gain control unit controls the excitation laser 118a according to the intensity of the radiation light input from the radiation light detection sensor 18a.

The optical modulator 115c includes a radiation light detection sensor 18a that detects radiation light emitted from the first doped waveguide 15a and the second doped waveguide 16a. Therefore, it is optional to measure the intensity of the transmission light by dividing part of the transmission light by a beam splitter or the like. Since the optical modulator 115c may measure the intensity of the transmission light without dividing part of the transmission light, there is no possibility that the transmission light is reduced due to the measurement of the intensity.

Table 2 illustrates a comparison between the optical modulator according to the embodiment and another technique. In Table 2, EDFA illustrates the characteristics when the light is amplified by an EDFA. SOA illustrates the characteristics when the light is amplified by an SOA. EDWA illustrates the characteristics of the optical modulator according to the embodiment.

TABLE 2

| | EDFA | SOA | EDWA |
|---|---|---|---|
| Optical Gain Characteristics | Very | Very | Very |
| | Good | Good | Good |
| NF Characteristics | Very | Moderate | Very |
| | Good | | Good |
| Efficiency | Very | Good | Very |
| | Good | | Good |
| Size | Not | Very | Good |
| | Good | Good | |
| Application Position | Very | Not | Very |
| Flexibility | Good | Good | Good |

When light is amplified by an EDFA, optical gain characteristics, NF characteristics, efficiency, and flexibility are very good. However, since the EDFA has an optical fiber having a length of several meters, there is a problem that the size is increased. When light is amplified by an SOA, the optical gain characteristics are very good and downsizing is possible. However, an SOA has a problem that it is not preferable to use an SOA for amplifying an optical signal modulated by a modulator because a waveform deteriorates due to a pattern effect.

Since the optical modulator according to the embodiment for amplifying light by an EDWA is a digital coherent optical receiver which amplifies only one frequency band, the optical gain characteristics are improved. Since the optical modulator according to the embodiment provides optical amplification on the transmission side, optical SN is high and the influence of noise light is negligible. In the optical modulators according to Embodiments 2-2 and 2-3, it is optional to use a multiplexer such as a WDM coupler by using the surplus ports of a certain directional coupler in advance. Since the optical reception device according to the embodiments has a structure in which a plurality of optical paths are amplified with a single excitation light source without actual insertion loss, the excitation efficiency is improved. Since the optical reception device according to the embodiment is excited backward, the excitation efficiency is further improved. In the optical modulator according to the embodiment, since the waveguide type EDFA doped with erbium ions (Er⁺³) is integrated with the modulator manufactured by a waveguide as a digital coherent transceiver, the flexibility is high.

Modification Example of Optical Modulator

In the optical modulators 115a to 115c, a waveguide type EDFA doped with erbium ions (Er⁺³) is used. However, in the optical modulator according to the embodiment, a waveguide type EDFA doped with another rare earth ion such as praseodymium ion (Pr⁺³) may be used.

In the optical modulators 115a to 115c, the modulation unit includes two modulation circuits, a first QPSK circuit 11a, and a second QPSK circuit 12a. However, in the optical modulator according to the embodiment, the number of modulation circuits included in the modulation unit may be two or more.

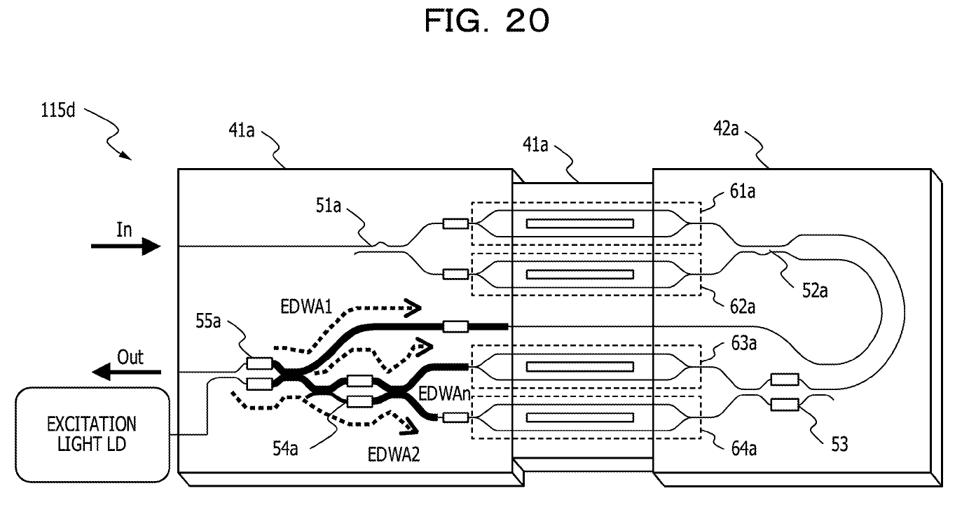

FIG. 20 is an internal block diagram of an optical modulator 115d according to a modification example.

The optical modulator 115d is formed by a first planar lightwave circuit 41a, a second planar lightwave circuit 42a, and an LN element 43a and is a multi-valued variable modulator including a first coupler 51a to a fifth coupler 55a, a first modulation circuit 61a to a fourth modulation circuit 64a. The first coupler 51a to the third coupler 53a are 3 dB couplers. The fourth coupler 54a to the fifth coupler 55a are variable couplers. The first modulation circuit 61a to the fourth modulation circuit 64a are Mach-Zehnder type modulators.

In the optical modulator 115d, a waveguide type EDFA doped with erbium ions (Er⁺³) is arranged between the fifth coupler 55a, the second coupler 52a, and the third modulation circuit 63a to the fourth modulation circuit 64a. In the optical modulator 115d, the excitation light is introduced from the surplus port of the fifth coupler 55a, whereby the waveguide type EDFA doped with the erbium ions (Er⁺³) functions as an amplifier.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical reception device comprising:
an optical waveguide substrate that includes:
a polarization beam splitter that divides reception light into an X polarization component and a Y polarization component orthogonal to the X polarization component,
a beam splitter that divides local light,
a pair of optical hybrid circuits that causes each of the X polarization component and the Y polarization component to interfere with the divided local light,
a first optical waveguide through which the reception light passes,
a second optical waveguide through which the X polarization component passes,
a third optical waveguide through which the Y polarization component passes, and
a fourth optical waveguide through which the local light passes,
wherein at least one of the first to fourth optical waveguides is doped with rare earth ions for amplifying light having a predetermined frequency when excitation light is introduced.

2. An optical reception device comprising:
an optical waveguide substrate that includes:
a polarization beam splitter that divides reception light into an X polarization component and a Y polarization component orthogonal to the X polarization component,
a beam splitter that divides local light,
a pair of optical hybrid circuits that causes each of the X polarization component and the Y polarization component to interfere with the divided local light,
a first optical waveguide through which the reception light passes,
a second optical waveguide through which the X polarization component passes,
a third optical waveguide through which the Y polarization component passes, and
a fourth optical waveguide through which the local light passes,
wherein at least one of the first optical waveguide and the fourth optical waveguide is doped with rare earth ions for amplifying light having a predetermined frequency when excitation light is introduced.

3. The optical reception device according to claim 2,
wherein the optical waveguide substrate includes a first optical multiplexer that multiplexes the excitation light for exciting the rare earth ions and the reception light and outputs the multiplexed light to the polarization beam splitter, and
wherein the first optical waveguide includes a first doped waveguide arranged between the first optical multiplexer and the polarization beam splitter and doped with the rare earth ions.

4. The optical reception device according to claim 2,
wherein the optical waveguide substrate includes a second optical multiplexer that multiplexes excitation light for exciting the rare earth ions and the local light and outputs the multiplexed light to the beam splitter, and
wherein the fourth optical waveguide includes a second doped waveguide arranged between the second optical multiplexer and the beam splitter and doped with the rare earth ions.

5. An optical reception device comprising:
an optical waveguide substrate that includes:
a polarization beam splitter that divides reception light into an X polarization component and a Y polarization component orthogonal to the X polarization component,
a beam splitter that divides local light,
a pair of optical hybrid circuits that causes each of the X polarization component and the Y polarization component to interfere with the divided local light,
a first optical waveguide through which the reception light passes,
a second optical waveguide through which the X polarization component passes,
a third optical waveguide through which the Y polarization component passes, and
a fourth optical waveguide through which the local light passes,
wherein at least one of the second optical waveguide, the third optical waveguide, and the fourth optical waveguide is doped with rare earth ions for amplifying light having a predetermined frequency when excitation light is introduced.

6. The optical reception device according to claim 5,
wherein the optical waveguide substrate includes a first optical multiplexer that multiplexes excitation light for exciting the rare earth ions with the reception light, and
wherein the second optical waveguide and the third optical waveguide include a reception light doped waveguide arranged between the polarization beam splitter and the pair of optical hybrid circuits and doped with the rare earth ions.

7. The optical reception device according to claim 5,
wherein the beam splitter includes:
a first port to which the local light is input,
a second port to which excitation light for exciting the rare earth ions is input, and
a third port and a fourth port that respectively output the divided local light, and
wherein the fourth optical waveguide includes a local light doped waveguide arranged between the beam splitter and the pair of optical hybrid circuits and doped with the rare earth ions.

8. An optical modulator comprising:
a demultiplexer that demultiplexes input light into at least two light beams;
a modulator that modulates the light demultiplexed by the demultiplexer; and
a multiplexer that multiplexes the light modulated by the modulator and outputs the multiplexed light as transmission light,
wherein the multiplexer includes:
an optical waveguide doped with rare earth ions for amplifying light having a predetermined frequency, and
an introduction port that introduces excitation light for exciting the rare earth ions in the optical waveguide.

9. The optical modulator according to claim 8,
wherein the multiplexer includes multiplexing elements that multiplex a plurality of light beams input to an input port to generate transmission light, and
wherein the optical waveguide includes a plurality of optical waveguides connected to ports of the multiplexing elements.

10. The optical modulator according to claim 9,
wherein the introduction port is a port of the multiplexing element.

11. The optical modulator according to claim 8, further comprising:
a radiation light detection sensor that detects radiation light emitted from the optical waveguide.

12. An optical modulation method executed by an optical modulator, the method comprising:
demultiplexing input light into at least two light beams;
modulating the demultiplexed light;
introducing excitation light for exciting rare earth ions into an optical waveguide doped with the rare earth ions for amplifying light having a predetermined frequency;
passing the modulated light through the optical waveguide doped with the rare earth ions for amplifying light having the predetermined frequency; and
outputting the light having passed through the optical waveguide as transmission light.
